(19) United States
(12) Patent Application Publication
(10) Pub. No.: US 2004/0142119 A1
(43) Pub. Date: Jul. 22, 2004

(54) Liquid crystal display and method for manufacturing the same

(76) Inventor: Tomio Tanaka, Tokyo (JP)

Correspondence Address: WILDMAN, HARROLD, ALLEN & DIXON, 225 WEST WACKER DRIVE, CHICAGO, IL, 60606, US

(21) Appl. No.: 10/747,496

(22) Filed: Dec. 29, 2003

(30) Foreign Application Priority Data
Dec. 27, 2002 (JP) 2002-381588

(51) Int. Cl. C09K 19/00

(52) U.S. Cl. 428/1.27

(57) ABSTRACT

A liquid crystal display with high speed of response and a wide angle of visibility, and a method for manufacturing the liquid crystal display, which is effective to cost reduction, are provided.

The above problem was solved by a liquid crystal display of a vertically aligned type comprising a first substrate, a second substrate, and a liquid crystal layer which is inserted in between said substrates, wherein hydrophobic alignment layers 5, which arranges a director of a liquid crystal molecule 4 in a direction of normal line of the substrate, are formed on the first substrate and on the second substrate, and a hydrophilic fine pattern region 6, in which the director of the liquid crystal molecule 4 is easily tilted to a predetermined direction, is formed in a part of said alignment layer. In this case, it is preferable that the direction of the director of the liquid crystal molecule which is tilted on the fine pattern region formed on the first substrate and the direction of the director of the liquid crystal molecule which is tilted on the fine pattern region formed on the second substrate are shifted from each other by an angle in a range of 70° to 110°.

### BACKGROUND OF THE INVENTION

1. Field of the Invention

The present invention relates to a liquid crystal display and a method for manufacturing the liquid crystal display, particularly to a liquid crystal display with high speed of response and wide angle of visibility which displays television images and computer images, and the method for manufacturing the same.

2. Description of the Related Art

Liquid crystal displays are widely used for various types of displays since thinning and low-voltage driving is possible. Particularly, the TN type liquid crystal display in which active switching elements such as TFT (Thin Film Transistor) are incorporated in each pixel exerts display performance equal to CRT, and is used for a display of personal computers and a television. However, the TN type liquid crystal display has drawbacks that the speed of response is slow and the angle of visibility is narrow. Various kinds of research and development have been conducted in order to solve the drawback of the TN type liquid crystal display. On the other hand, research and development is also being conducted on the vertically aligned type liquid crystal display in which a director of a liquid crystal molecule is arranged in a direction of normal line of a substrate.

The vertically aligned type liquid crystal display has advantages such that the front face contrast is excellent and rubbing treatment is not necessary in the manufacturing process, so that various kinds of research and development are actively conducted. Even in the vertically aligned type liquid crystal display, similarly to the above mentioned TN type liquid crystal display, it is necessary to improve the angle of visibility and the speed of response.

A technology which controls a tilt direction of the liquid crystal molecule so that the tilt direction of the liquid crystal molecule becomes plural in one pixel, i.e. a multidomain technology has been proposed for the above-described demands. As the multidomain technology, as shown in FIG. 9, placing of a projecting structure 97 at an arbitrary position on a foundation of an alignment layer 96 has been proposed (for example, see Fujitsu FIND, vol. 19, No. 5, 2001 (FIGS. 1 to 3)). In the multidomain technology, a liquid crystal molecule 94 is slightly tilted following a slope of the structure 97 when voltage is not applied. When the voltage is applied, the slightly tilted liquid crystal molecule 94 initially starts to tilt along the tilt direction, and liquid crystal molecules 95 which are not on the structure 97 are also tilted in sequence to the same direction, influenced by the liquid crystal molecule 94. That is to say, the structure 97 being a starting point, alignment of the liquid crystal molecules 94 and 95 is controlled.

As alignment control of the liquid crystal using a projecting structure, an example in which the structure is provided two-dimensionally in liner and rectangular shape to form a four-divisional domain structure, and an example in which the structure is provided one-dimensionally in dots to form a domain structure in which the liquid crystal molecules are tilted in all directions, are known.

On the other hand, as examples of alignment control of the liquid crystal by not using a structure, a method in which a horizontally aligned region and a vertically aligned region are alternately provided on a substrate (for example, see Japanese Patent Application Laid-Open No. 10-206834 (FIGS. 1 and 5)), a method in which a thin film component molecule tilted in a predetermined direction is formed in blocks in one pixel (for example, see Japanese Patent Application Laid-Open No. 11-167114 (FIGS. 5 and 12), and Japanese Patent Application Laid-Open No. 2001-281669 (FIGS. 4 to 7)), and the like are cited.

However, in the above mentioned alignment control utilizing the projecting structure, there is a drawback that the cost of the liquid crystal display is increased, because plural processes are required to form the structure. Further, since a liquid crystal material used there spontaneously makes a twist structure in a cell gap, it is necessary that the liquid crystal material contains a large amount of chiral agent. Consequently, the response time tends to be lengthened.

Moreover, in the above mentioned alignment control without the structure, since the blocks are formed within the minute pixel, there is the problem that the manufacturing process becomes complicated and the response time is not sufficient.

### SUMMARY OF THE INVENTION

The present invention is achieved in view of the above mentioned problems, and an object of the present invention is to provide a liquid crystal display with high speed of response and wide angle of visibility, and a method for manufacturing the liquid crystal display, which is effective for cost reduction.

In order to solve the above problem, the invention provides a liquid crystal display of a vertically aligned type comprising a first substrate, a second substrate, and a liquid crystal layer which is inserted in between said substrates, wherein hydrophobic alignment layers, which arranges a director of a liquid crystal molecule in a direction of normal line of the substrate, are formed on the first substrate and on the second substrate, and a hydrophilic fine pattern region, in which the director of the liquid crystal molecule is easily tilted to a predetermined direction, is formed in a part of said alignment layer.

In the present invention, the liquid crystal molecules on the hydrophilic fine pattern region are easily tilted to the predetermined direction when power is on, so that other liquid crystal molecules are tilted in unison, the liquid crystal molecules on the fine pattern region being the starting point. As a result, the response time of the liquid crystal can be shortened.

In the present invention, it is preferable that the direction of the director of the liquid crystal molecule which is tilted in the fine pattern region formed on the first substrate and the direction of the director of the liquid crystal molecule which is tilted in the fine pattern region formed on the second substrate are shifted from each other by an angle in a range of 70° to 110°.

Since the directions of the directors which are tilted on the upper and lower substrates sandwiching the liquid crystal layer are shifted from each other so as to be orthogonal or substantially orthogonal to each other, a twist power is not required to the liquid crystal molecule itself. Therefore, viscosity of the liquid crystal can be reduced since the chiral agent contained in the liquid crystal layer can be reduced. As a result, the response time of the liquid crystal can be shortened. That is to say, the invention is characterized in that the twist structure when the power is on does not depend on the conventional helical arrangement of the liquid crystal itself containing a large amount of the chiral agent, but the alignment of the liquid crystal molecule is controlled by regulating the tilt direction of the liquid crystal molecule based on the shape of the fine pattern regions on the upper and lower substrates.

In the present invention, it is preferable that a shape of the fine pattern region is a triangle having an acute angle portion or a combined shape based on said triangle.

As mentioned above, when the power is on, the liquid crystal molecules on the triangle having the acute angle portion are rapidly tilted from the acute angle portion toward the facing side, so that the alignment of the liquid crystal molecule can be regulated in the direction based on the shape. Accordingly, the control of the alignment of the liquid crystal molecule can be freely performed by specifying the direction of which the acute angle portion of the triangle is facing.

Further in the present invention, it is preferable that the alignment layer is a hydrophobic film formed of fluorinated silicone or polyimide, and the fine pattern region is a hydrophilic region in which a hydrophilic group is given to the fluorinated silicone film or the polyimide film.

The region other than fine pattern region is the hydrophobic alignment layer, so that the director of the liquid crystal molecule is regulated so as to be arranged in the direction of normal line of the substrate. However, the regulation does not act on the hydrophilic fine pattern region, so that the liquid crystal molecule on the fine pattern region can be rapidly tilted and fall down when the power is on.

Moreover, the present invention provides a liquid crystal display substrate comprising a substrate and a hydrophobic alignment layer, which is formed on the substrate and arranges a director of a liquid crystal molecule in a direction of normal line of the substrate, wherein a hydrophilic fine pattern region, in which the director of the liquid crystal molecule is easily tilted to a predetermined direction, is formed in a part of the alignment layer.

Even in this case, for the same reason as the above description, it is preferable that the shape of the fine pattern region is a triangle having an acute angle portion or a combined shape based on said triangle. Further, it is preferable that the alignment layer is a hydrophobic film formed of fluorinated silicone or polyimide, and the fine pattern region is a hydrophilic region in which a hydrophilic group is given to the fluorinated silicone film or the polyimide film

Further, the present invention provides a method for manufacturing a liquid crystal display of a vertically aligned type comprising a first substrate, a second substrate, and a liquid crystal layer which is inserted in between said substrates wherein alignment layers, which arranges a director of a liquid crystal molecule in a direction of normal line of the substrate, are formed on the first substrate and on the second substrate, and a fine pattern region, in which the director of the liquid crystal molecule is easily tilted to a predetermined direction, is formed in a part of said alignment layer, comprising processes of: forming a hydrophobic alignment layer, to which hydrophilic treatment is possible, on a surface of the first substrate and the surface of the second substrate; and forming a hydrophilic fine pattern region by carrying out the hydrophilic treatment to a part of the alignment layer.

As mentioned above, by making a part of the coated hydrophobic alignment layer, the hydrophilic fine pattern region can be formed, so that the fine pattern region which can control the alignment of the liquid crystal can be formed by extremely simple process without forming the conventional structure or the special thin film. As a result, the liquid crystal display can be efficiently manufactured, and the cost of the liquid crystal display can be reduced.

Additionally, in the present invention, it is preferable that, in the process of forming the hydrophilic fine pattern region, a pattern to which the hydrophilic treatment is carried out is a triangle having an acute angle portion or a combined shape based on said triangle, and the shape of the pattern of the alignment layer formed on the first substrate to which hydrophilic treatment is carried out and the shape of the pattern of the alignment layer formed on the second substrate to which hydrophilic treatment is carried out are shifted from each other, on a plane view, by an angle in a range of 70° to 110°.

By a simple method in which the hydrophilic treatment is carried out with pattern shapes of both substrates to which hydrophilic treatment is carried out are placed so as to be orthogonal or substantially orthogonal to each other, alignment regulating pattern which achieves the twist structure of the liquid crystal molecules can be formed.

Further in the present invention, it is preferable that the hydrophilic treatment is carried out by exposure treatment using a mask having a photocatalyst layer.

Since the exposure is carried out by using the mask having the photocatalyst layer, the hydrophobic film can be changed to the hydrophilic extremely easily by the action of the photocatalyst during exposure, and also, the surface which the alignment control is extremely easily possible only by the exposure treatment can be formed.

As described above, according to the liquid crystal display of the present invention, since the hydrophilic fine pattern region is formed in a part of the alignment layer, the liquid crystal molecules on the fine pattern region easily begins to be tilted to the predetermined direction when the power is on, Then, other liquid crystal molecules are tilted in unison, the liquid crystal molecules on the fine pattern region as the starting point, and the response time of the entire liquid crystal layer can be shortened. The alignment of the liquid crystal molecule can be freely controlled by forming the shape of the fine pattern region arbitrarily.

According to the present invention, since it is not necessary that the liquid crystal molecule itself has twist power by shifting the directions of the directors, which are tilted on the upper and lower substrates sandwiching the liquid crystal layer, so as to be orthogonal or substantially orthogonal to each other, the chiral agent contained in the liquid crystal layer can be reduced. As a result, the viscosity of the liquid crystal can be reduced and the response time of the liquid crystal can be shortened.

According to the method for manufacturing the liquid crystal display of the present invention, since the hydrophilic fine pattern region can be formed by exposing the coated hydrophobic alignment layer, the fine pattern region which can control the alignment of the liquid crystal by the very simple process can be formed without forming the structure or the special thin film like the conventional liquid crystal display. As a result, the liquid crystal display can be efficiently manufactured, and the cost of the liquid crystal display can be reduced.

### BRIEF DESCRIPTION OF THE DRAWINGS

FIGS. 1A to 1C are schematic diagrams showing changes in a director of a liquid crystal molecule when voltage is applied to the substrates in a vertically aligned type liquid crystal display;

FIGS. 2A and 2B are schematic views illustrating a shape of a fine pattern region and a tilt direction of the liquid crystal molecules;

FIG. 3A is a plan view showing an example of the shape of the fine pattern region formed on a first substrate, and FIG. 3B is a plan view showing an example of the shape of the fine pattern region formed on a second substrate;

FIG. 4 is a plan view showing an example in which different fine pattern regions are formed on both substrates, and an alignment configuration of the liquid crystal molecule in a formed cell gap;

FIGS. 5A to 5D are explanatory views showing an example of a method for forming the fine pattern region using a photocatalyst;

FIGS. 6A to 6D are explanatory views showing another example of the method for forming the fine pattern region using the photocatalyst;

FIGS. 7A and 7B are explanatory views showing an example of a surface reaction in which the property of an alignment layer is changed from hydrophobic to hydrophilic;

FIG. 8 is a schematic sectional view showing an example of an usual liquid crystal display; and

FIG. 9 is an explanatory view showing an example of the conventional multidomain technology.

### DESCRIPTION OF THE PREFERRED EMBODIMENTS

The liquid crystal display and the method for manufacturing the same of the present invention will be described below referring to the drawings.

(Liquid Crystal Display)

The liquid crystal display of the present invention is a vertically aligned type liquid crystal display comprising a first substrate 1, a second substrate 2, and a liquid crystal layer 3 which is injected in between the facing substrates.

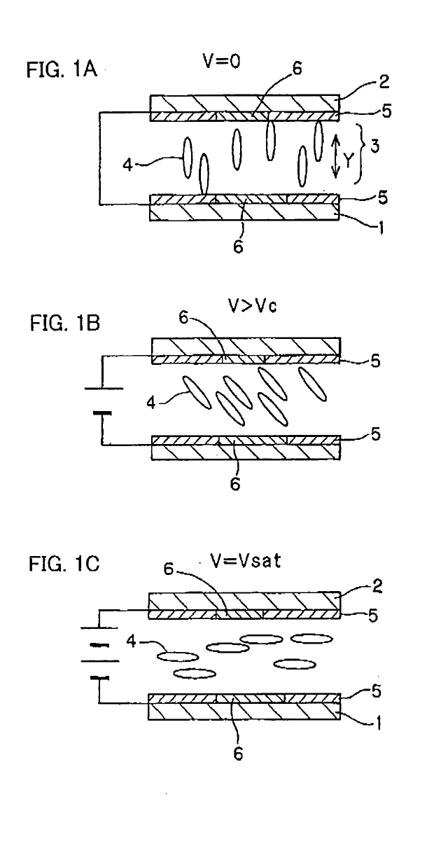

FIGS. 1A to 1C are schematic diagrams showing changes in the director of the liquid crystal molecule when the voltage is applied to the substrates in the vertically aligned type liquid crystal display. FIG. 1A shows an embodiment in which the director of a liquid crystal molecule 4 is arranged in a direction of normal of the substrate Y when the power is off (V=0), FIG. 1B shows an embodiment in the case where critical voltage V, at which the liquid crystal molecule 4 will begin to be tilted, is applied, and FIG. 1C shows an embodiment in the case where saturation voltage Vₛₐₜ, at which the liquid crystal molecule 4 is sufficiently tilted, is applied. The director means an unit vector expressing an average alignment direction of the liquid crystal molecule 4.

As shown in FIG. 1, in the vertically aligned type liquid crystal display of the present invention, hydrophobic alignment layers 5 which aligns the director of the liquid crystal molecule 4 to the direction of normal of the substrate Y are formed on the first substrate 1 and the second substrate 2, and hydrophilic fine pattern regions 6, in which the director of the liquid crystal molecule 4 is easily tilted to the predetermined direction, are further formed in a part of the alignment layer 5.

The alignment layers 5 are layers formed on the first substrate 1 and the second substrate 2, are the hydrophobic films having action to align the director of the liquid crystal molecule 4 toward direction of normal of the substrate Y when the voltage is off. Though the alignment layer 5 is originally hydrophobic, the alignment layer 5 can become hydrophilic by carrying out the hydrophilic treatment. For example, the alignment layer 5 is formed of hydrophobic resin such as fluorinated silicone resin for forming the hydrophobic film or polyimide resin for forming the vertically aligned film. Commercially available photosensitive resin such as the fluorinated silicone resin for forming a water-repellent film manufactured by GE Toshiba Silicones can be cited as an example of the fluorinated silicone resin for forming the hydrophobic film, and the commercially available photosensitive resin such as JALS-688 manufactured by JSR Corporation which is the polyimide resin composition for forming the vertically aligned film, can be cited as an example of the polyimide resin for forming the vertically aligned film. A thickness of the alignment layer 5 is not particularly limited. However, it is preferable that the thickness of the alignment layer 5 ranges from 10 nm to 100 nm.

The fine pattern region 6 is formed on the alignment layer 5. The fine pattern region 6 is a hydrophilic region which is obtained by carrying out the hydrophilic treatment to the hydrophobic alignment layer 5.

It is preferable to design a shape of the fine pattern region 6 so that the liquid crystal molecules 4 located on the region is easily tilted when the voltage is applied to the substrates. Since the liquid crystal molecules 4 are easily tilted when the voltage is applied to the substrates by designing the fine pattern region 6 as mentioned above, there are advantages that the voltage at which the tilting begins to occur (referred to as critical voltage Vc) can be reduces compared with the conventional devices and the time since the liquid crystal molecules 4 on the region begins to be tilted till the whole liquid crystal molecules 4 are tilted (also referred to as response time) is shortened.

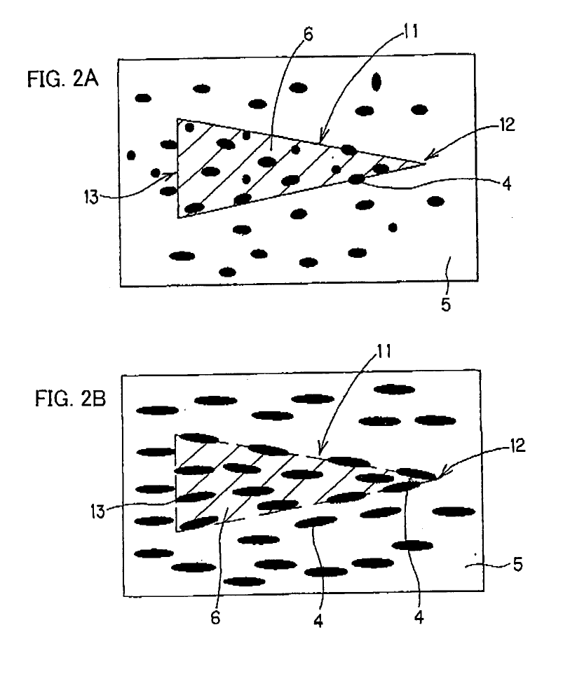

As long as the shape of the hydrophilic fine pattern region 6 has the above mentioned effect, it is not particularly limited. However, as shown in FIG. 2A as an example, the shape is preferably a triangle 11 having an acute angle portion 12 or a combined shape based on the triangle 11. Particularly in the case where the triangular fine pattern region 6 shown in FIG. 2A is formed, there is an advantage that the response time of the liquid crystal alignment is shortened. The reason is as follows; it is presumed that the liquid crystal molecules 4 near the acute angle portion 12 will initially begin to be tilted toward an facing side 13 of the acute angle portion 12 as they are falling down, and other liquid crystal molecules 4 on the fine pattern region 6 will begin to be tilted in unison following the liquid crystal molecules 4 initially tilted as shown in FIG. 2B, i.e. the liquid crystal molecules 4 are tilted in unison in a predetermined direction.

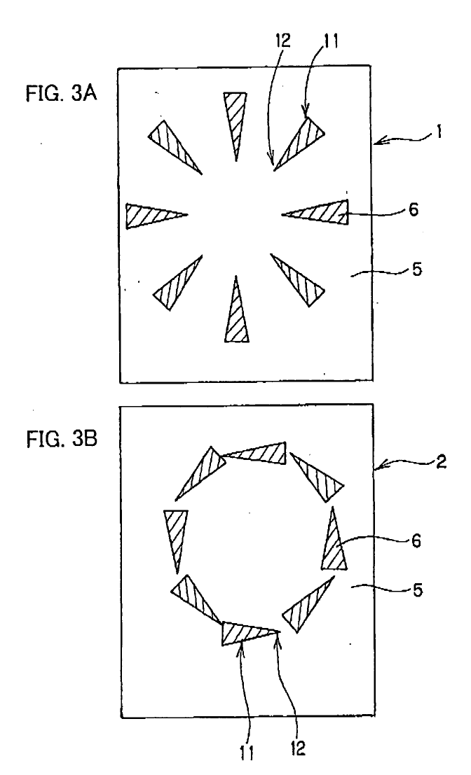

FIG. 3A is a plan view showing an example of the shape of the fine pattern region 6 formed on the first substrate 1, and FIG. 3B is a plan view showing an example of the shape of the fine pattern region 6 formed in the second substrate 2. FIG. 3A is a configuration in which the fine pattern region 6 formed from the triangles 11 having the acute angle portions 12 are radially arranged so that the acute angle portions 12 are facing toward the center of the pixel. FIG. 3B is a configuration in which the fine pattern region 6 formed from the triangles 11 having the acute angle portions 12 are arranged so that the acute angle portions 12 are orthogonal to a central direction of the pixel to form a circle with these triangles 11. That is to say, when the voltage is applied, the shapes of FIGS. 3A and 3B are designed so that the tilted alignment direction of the liquid crystal molecules on the first substrate 1 is orthogonal or substantially orthogonal to the tilted alignment direction of the liquid crystal molecules on the second substrate 2. Since the liquid crystal molecules in the cell gap, when the voltage is applied, can be controlled to be a twist structure by forming the above mentioned shape, the liquid crystal molecules can be tilted in many directions. As a result, the accordingly alignment controlled liquid crystal display has a wide angle of visibility and uniform display performance though observed from various directions.

Particularly, in the present invention, since the fine pattern region shown in FIG. 3 is formed within a single pixel, the alignment of the liquid crystal molecule can be controlled in unit of one pixel.

Further, in the present invention, since the liquid crystal molecule can be regulated in a twist structure by forming the shape shown in FIG. 3, a content of the chiral agent can be reduced. As a result, a viscosity of the liquid crystal can be reduced, and the response speed of the liquid crystal molecules can be increased when the voltage is applied.

FIG. 4 is a plan view showing an example in which different fine pattern regions are formed on the both substrates. FIG. 4 shows the shape of the alignment of the liquid crystal molecule 4, when the voltage is applied, in a case where a cell gap is formed with the first substrate 1 on which the fine pattern region 6 is formed in the shape shown in FIG. 3A and the second substrate 2 on which the fine pattern region 6 is formed in the shape shown in FIG. 3B, and the liquid crystal is injected in the cell gap. A configuration A, in which the triangles 11 formed on the upper and lower substrates 1 and 2 are placed so as to be orthogonal each other, is illustrated in the center of FIG. 4. And a configuration B showing the twist state, in which the liquid crystal molecules 4 are gradually turned as headed from near the first substrate 1 toward near the second substrate 2, is illustrated outside of the configuration A.

In the present invention, as shown in FIG. 3 and FIG. 4, it is preferable that the direction of the director of the liquid crystal molecule 4 which is tilted on the fine pattern region 6 formed on the first substrate 1 and the direction of the director of the liquid crystal molecule 4 which is tilted on the fine pattern region 6 formed on the second substrate 2 are shifted from each other by an angle θ from 70° to 110°. The twist structure when the voltage is applied can be made dependent on the shape of the fine pattern regions 6 of the upper and lower substrates 1 and 2 by making the directions of the directors tilted on the upper and lower substrates 1 and 2 sandwiching the liquid crystal layer are orthogonal or substantially orthogonal to each other to an angle θ from about 70° to 110°.

As described above, in the liquid crystal display of the present invention, since the liquid crystal molecules on the hydrophilic fine pattern region can be easily tilted in a predetermined direction when the voltage is applied, other liquid crystal molecules can be tilted in unison, as the liquid crystal molecules on the fine pattern region being the starting point, and the response time of the liquid crystal can be shortened. Further, since the liquid crystal molecules in the cell gap can be regulated in the twist structure, the liquid crystal molecules can be tilted in many directions. As a result, the accordingly alignment controlled liquid crystal display has a wide angle of visibility and uniform display performance though observed from various directions.

Next the substrate on which the above mentioned alignment layer is formed will be described. As shown in the liquid crystal display of FIG. 8, the first substrate land the second substrate 2 constitute either one of a color filter substrate 101 or a device (TFT) substrate 102.

The color filter substrate 101 is a substrate on which a matrix shaped color filter layer 107 is formed on a substrate 112. In more detail, it is a substrate comprising the color filter layer 107 forming each pixel region of R (Red), G (Green), and B (Blue) on the inside surface of the substrate 112 and a black matrix layer 108 which is formed in a peripheral portion of the pixel region in order to shield leaking light. A common transparent electrode 109 is formed on the color filter layer 107, and the hydrophobic alignment layer (not shown in the figure) in which the director of the liquid crystal molecule is arranged in the direction of normal line of the substrate is further formed on the common transparent electrode 109. The color filter substrate 101 constituting the present invention is not particularly limited as long as it has a currently usually used configuration. One having configuration not described in the above may also be used.

On the other hand, the device substrate 102 is a substrate on which matrix shaped TFT elements 105 are formed as individual pixel region on the substrate 112. In more detail, pixel electrodes 104 arranged in a matrix shape, thin film field transistor (TFT) elements 105, and line electrodes 106 are formed on the inside surface of the substrate 112, and the hydrophobic alignment layer (not shown in the figure) in which the director of the liquid crystal molecule is arranged in the direction of normal line of the substrate is further formed on the pixel electrode 104. The device substrate 102 constituting the present invention is not particularly limited as long as it has a currently usually used configuration. One having configuration not described in the above may also be used.

In the liquid crystal display, a glass substrate, a transparent plastic substrate or the like is cited as the, substrate 112, and the transparent electrode made of indium tin oxide (ITO), indium dioxide, indium zinc oxide (IZO), and the like can be cited as the pixel electrode 104 and the transparent electrode 109. A spacer for setting a clearance between the color filter substrate 101 and the device substrate 102 to a predetermined value is formed to keep the cell gap at a constant value. Polarizing plates 113 are provided on the outside of each substrate (see FIG. 8), and a backlight is provided further outside on the device substrate side.

(Method for Manufacturing Liquid Crystal Display)

The method for manufacturing the liquid crystal display will be described below. The method for manufacturing the liquid crystal display of the present invention is a method for manufacturing the liquid crystal display of the above mentioned configuration. The method is characterized by the following processes.

(1) A process of forming the hydrophobic alignment layers, to which hydrophilic treatment is possible, on the surface of the first substrate (for example, on the surface of the color filter substrate) and the surface of the second substrate (for example, on the surface of the device substrate).

(2) A process of forming the hydrophilic fine pattern region by carrying out the hydrophilic treatment to a part of the alignment layer.

Other manufacturing processes for manufacturing the liquid crystal display such as the processes of forming the color filter layer, the black matrix layer, transparent electrode layer, the THT elements, and the like shown in FIG. 8 are the same as the conventionally known method.

In the above process of (1), the above mentioned fluorinated silicone resin for forming the hydrophobic film or the polyimide resin for forming the vertically aligned film can be cited as the resin for forming the alignment layer to which hydrophilic treatment is possible. These resins are coated over the entire surface of the both substrates by coating methods such as spin coating or various kinds of printing methods.

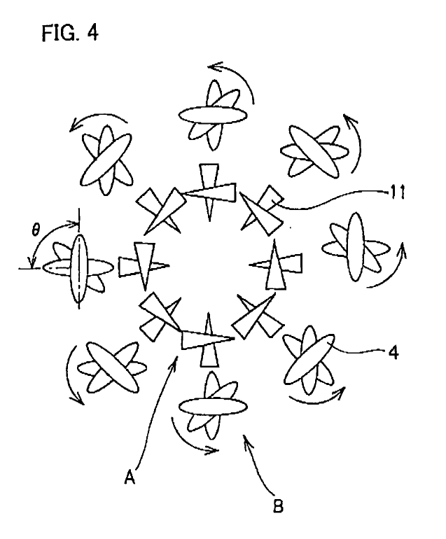

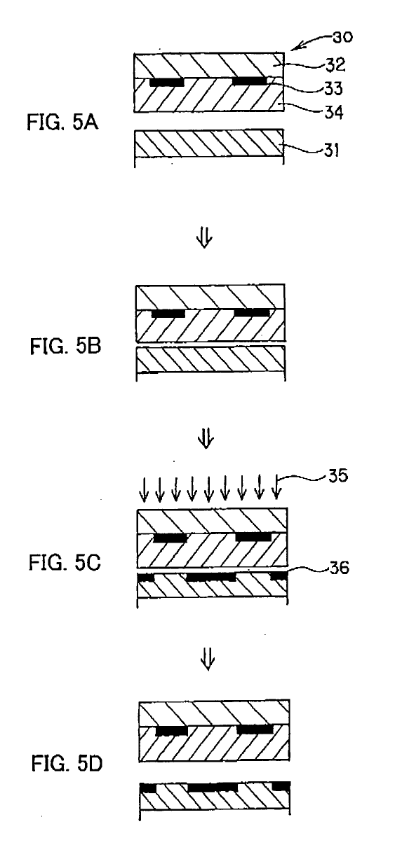

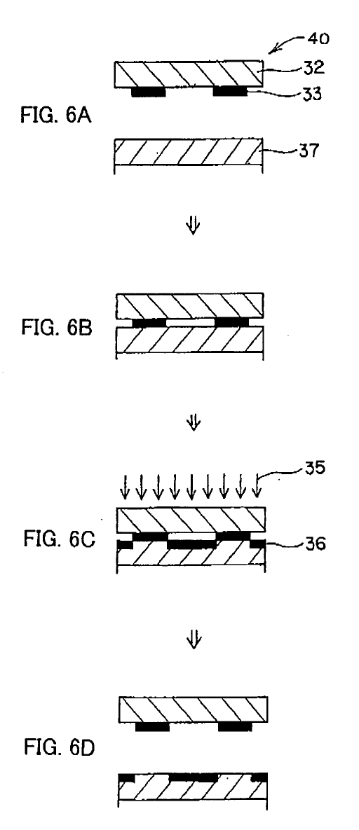

In the above process of (2), as shown in FIGS. 5A to 5D and FIGS. 6A to 6D,

(i) A method in which hydrophilic treatment is carried out only to the exposed portion to form a fine pattern region 36 by exposing the hydrophobic film, which is the alignment layer, with a mask 30 having a photocatalyst layer 34 (see FIGS. 5A to 5D),

(ii) A method in which, after the hydrophobic resin containing the photocatalyst is coated to form a photocatalyst containing alignment layer 37, hydrophilic treatment is carried out only to the exposed portion to form the fine pattern region 36 by exposing the alignment layer 37 (see FIGS. 6A to 6D), and the like can be cited as the methods for carrying out the hydrophilic treatment to a part of the alignment layer.

In the process of (i), the fluorinated silicone resin or the polyimide resin can be cited as a hydrophobic alignment layer 31. As shown in FIGS. 5A to 5D, the hydrophilic treatment utilizing the mask having the photocatalyst layer is a method for treating in which the mask 30 which the photocatalyst layer 34 is formed on a substrate 32 with a mask pattern 33 is formed thereon and the first substrate or the second substrate which the hydrophobic alignment layer 31 is formed thereon are prepared (FIG. 5A), the mask 30 having the photocatalyst layer 34 is faced to the hydrophobic alignment layer 31 with a predetermined clearance (FIG. 5B), exposure light 35 is irradiated (FIG. 5C), and the hydrophilic fine pattern region 36 is formed (FIG. 5D).

The photocatalyst layer 34 contains titanium oxide, which is a photocatalyst, in a binder. Titanium oxide is preferably anatase-type titanium oxide. It is preferable that the titanium oxide is contained in the proportion of 20 to 40 wt % in the binder. It is preferable that an average particle size of the titanium oxide is in a range of about 5 to about 20 μm. ZnO and the like can be used as the photocatalyst instead of titanium oxide. A photoelectrochemical reaction occurs in the photocatalyst particle by irradiating the photocatalyst layer 34 with, e.g. the exposure light 35 having a wavelength not more than 380 nm, and the exposed hydrophobic alignment layer 31 can be oxidized or reduced. As a result, a part of the hydrophobic alignment layer 31 can be changed to the hydrophilic fine pattern region.

It is preferable that the clearance between the mask 30 and the hydrophobic alignment layer 31 is a clearance which can easily generate active oxygen species within the gap by the photocatalytic reaction and can make the active oxygen species act. It is preferable that the mask 30 and the hydrophobic alignment layer 31 are placed so that the clearance is in a range of 5 to 20 μm.

In the process of (ii), the fluorinated silicone coated film or the polyimide coated film, which contains the above mentioned photocatalyst, can be cited as the hydrophobic alignment layer 37. As shown in FIG. 6, the hydrophilic treatment is a treating method in which a mask 40 which the mask pattern 33 is formed on the substrate 32 and the first substrate or the second substrate on which the hydrophobic alignment layer 31 containing the photocatalyst is formed are prepared (FIG. 6A), the mask 40 is faced to the hydrophobic alignment layer 37 containing the photocatalyst with a predetermined clearance (FIG. 6B), by irradiating exposure light 35 (FIG. 6C), the hydrophilic fine pattern region 36 is formed (FIG. 6D).

The hydrophobic alignment layer 37 contains titanium oxide which is the photocatalyst in the binder. Similarly to the above description, titanium oxide is preferably anatase-type titanium oxide. It is preferable that the titanium oxide is contained in the proportion of 20 to 40 wt % in the binder. It is preferable that the average particle size of the titanium oxide is in a range of about 5 to about 20 μm. ZnO and the like can be used as the photocatalyst instead of titanium oxide. A photoelectrochemical reaction occurs in the contained photocatalyst particle by irradiating the hydrophobic alignment layer 37 with, e.g. the exposure light 35 having the wavelength not more than 380 nm, and the hydrophobic alignment layer 37 can be oxidized or reduced. As a result, apart of the hydrophobic alignment layer 37 can be changed to the hydrophilic fine pattern region. The clearance between the mask 40 and the hydrophobic alignment layer 37 is the same as the process of i). Comparing the process of i) to the process of ii), the process of i) can be applied more preferably.

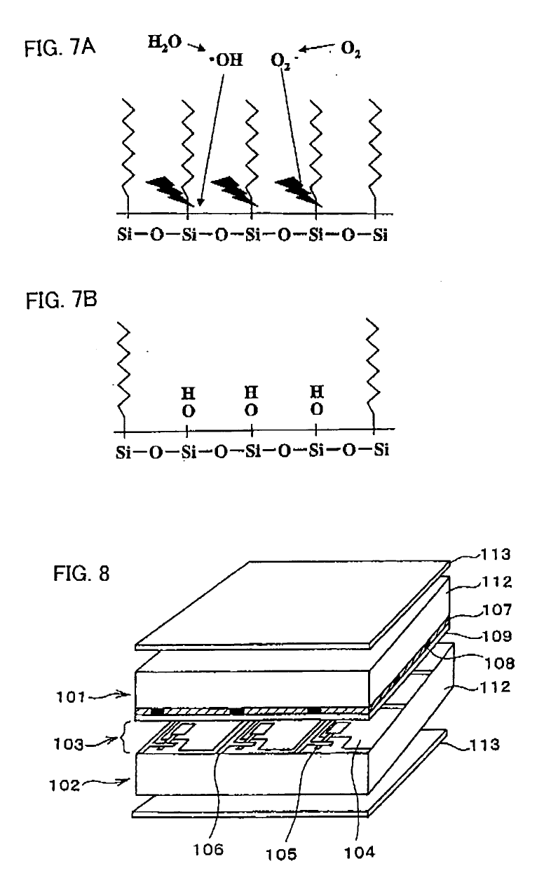

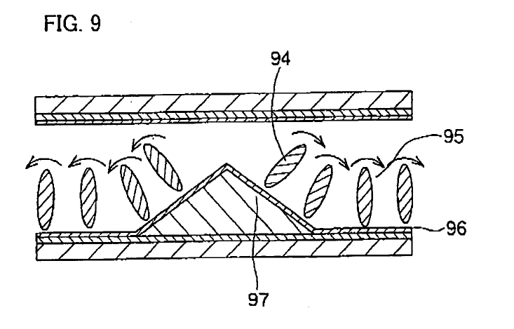

FIGS. 7A and 7B are explanatory views showing an example of a surface reaction in which a part of the hydrophobic alignment layer is changed to the hydrophilic fine pattern region. FIG. 7A shows a state in which the active oxygen species attack a side chain of the surface of the hydrophobic alignment layer to cut a bonding of the side chain, and FIG. 7B shows a state in which hydroxyl groups are bonded to the cut parts to change to the hydrophilic property.

In the hydrophilic treatment generating the surface reaction shown in FIGS. 7A and 7B, it is preferable that the hydrophobic alignment layer and the mask having the photocatalyst layer are placed with a predetermined clearance (for example, 5 to 20 μm). By placing the hydrophobic alignment layer and the mask having the photocatalyst layer with the predetermined clearance, the active oxygen species can be easily generated by the photocatalytic reaction in the clearance. Active oxygen or active hydroxyl group, which is generated due to the photoelectrochemical reaction in the photocatalyst particle, can be cited as the active oxygen species. These active oxygen species attack the side chain (for example, alkyl side chain) shown in FIG. 7A to cut the bonding of the side chain. To the parts where the side chain has been cut, the active oxygen species take the place and are bonded to change to the hydrophilic property as shown in FIG. 7B.

In the manufacturing method, it is preferable that the shape of the hydrophilic treatment pattern for forming the fine pattern region by the hydrophilic treatment is formed in the triangle having an acute angle portion or the combined shape based on the triangle as shown in FIG. 3. Further, it is preferable that the shape of the pattern of the alignment layer formed on the first substrate to which hydrophilic treatment is carried out and the shape of the pattern of the alignment layer formed on the second substrate to which hydrophilic treatment is carried out are shifted from each other, on a plane view, by an angle in a range of 70° to 110°. In the present invention, the alignment regulating pattern which achieves the twist structure of the liquid crystal molecule can be formed by the very simple method in which the hydrophilic treatment pattern (for example, exposure mask pattern) having the predetermined shape is formed, and the hydrophilic treatment is carried out using it.

As described above, in the method for manufacturing the liquid crystal display of the present invention, the fine pattern region which can control the alignment of the liquid crystal can be formed by the very simple process, so that the liquid crystal display can be efficiently manufactured, and the cost of the liquid crystal display can be reduced.

### EXAMPLES

The present invention will be further described in details referring to examples and comparative examples.

### Example 1

<Process of Forming Alignment Control Film on Color Filter Substrate Side>

At first, the color filter substrate 1 on which ITO is formed as the transparent electrode 9 was prepared, the hydrophobic resin composition (polyimide resin composition for vertically aligned film, JALS-688, manufactured by JRS Corporation) to which hydrophilic treatment is possible was spin-coated on the transparent electrode 9, and the hydrophobic alignment layer having the thickness of 60 nm was formed.

Then, the mask 30 having the photocatalyst layer 33 was placed on the hydrophobic alignment layer so that the clearance of about 20 μm is maintained, and exposed with ultraviolet rays having the wavelength of 200 to 370 nm. The exposed portion was changed from the hydrophobic alignment layer to the hydrophilic alignment layer.

In the mask 30, the predetermined mask pattern 33 made of chromium thin film is formed on the substrate 32, and the photocatalyst layer 34 having the thickness of 0.05 to 0.5 μm, which contains the anatase-type titanium oxide particles as the photocatalyst, is further formed on the mask pattern 33. As shown in FIG. 3A, the mask pattern is a configuration in which the fine pattern region 6 formed from the triangles 11 having the acute angle portions 12 are radially arranged so that the acute angle portions 12 are facing toward the center of the pixel. In a size of each formed triangle, the triangle is an isosceles triangle with the angle of the acute angle portion in a range of 10 to 30°, and a length of the side facing to the acute angle portion 12 is in a ranged of 10 to 50 μm. In the photocatalyst layer 34, the titanium oxide particles in a range of about 10 to about 100 wt % are contained in the binder resin (silicone resin). 100 wt % of titanium oxide means the case in which the photocatalyst layer 34 is formed only with titanium oxide.

The color filter substrate, in which a part of the hydrophobic alignment layer on the transparent electrode of the color filter substrate is changed to the fine pattern region comprising the hydrophilic alignment layer, was formed in the above described way.

<Process of Forming Alignment Control Film on Device Substrate Side>

At first, the device substrate 2 on which ITO is formed as the pixel electrode 4 is prepared, the hydrophobic resin composition (polyimide resin composition for vertically aligned film, JALS-688, manufactured by JRS Corporation) to which hydrophilic treatment is possible is spin-coated on the pixel electrode 4, and the hydrophobic alignment layer having the thickness of 60 to 100 nm is formed.

Then, the mask 30 having the photocatalyst layer 33 is placed on the hydrophobic alignment layer so that the clearance is maintained in a range of about 10 to about 25 μm, and exposed with ultraviolet rays having the wavelength of 200 to 370 nm. The exposed portion was changed from the hydrophobic alignment layer to the hydrophilic alignment layer.

In the mask 30, the predetermined mask pattern 33 made of chromium thin film was formed on the substrate 32, and the photocatalyst layer 34 having the thickness of 0.05 to 0.5 μm, which contains the anatase-type titanium oxide particles as the photocatalyst, was further formed on the mask pattern 33. As shown in FIG. 3b, the mask pattern is a configuration in which the fine pattern region 6 formed from the triangles 11 having the acute angle portions 12 are arranged so that the acute angle portions 12 are orthogonal to a central direction of the pixel to form a circle with these triangles 11. In the size of each formed triangle, the triangle is the isosceles triangle with the angle of the acute angle portion in a range of 10 to 30°, and the length of the side facing to the acute angle portion 12 is in a range of 10 to 50 μm. When the mask for the color filter substrate and the mask for the device substrate are superposed and viewed from the plane, the both mask patterns are formed so that the triangles formed in each mask are turned at an angle of 90°.

The type or the content of the photocatalyst constituting the photocatalyst layer 34 is the same as the above mentioned mask for the color filter substrate.

The device substrate, in which a part of the hydrophobic alignment layer on the pixel electrode of the device substrate is changed to the fine pattern region comprising the hydrophilic alignment layer, was formed in the above-described way.

<Liquid Crystal Display>

The color filter substrate and the device substrate, which were formed by the above described method, were faced to each other with a predetermined distance, and the liquid crystal was injected in between those to form the liquid crystal layer. In the liquid crystal display, the hydrophobic alignment layers, which arrange the director of the liquid crystal molecule in the direction of normal line of the substrate, are formed on both the color filter substrate and the device substrate, and the hydrophilic fine pattern region in which the director of the liquid crystal molecule is easily tilted to the predetermined direction is formed in a part of the alignment layer.

In the liquid crystal display, since the liquid crystal molecules are shifted at an angle of about 90°, the content of the chiral agent in the liquid crystal layer could be reduced by about 2% compared with the conventional type of liquid crystal display. When the power of the liquid crystal display is turned on, the response time of the liquid crystal was about 15 msec, while the response time is about 20 msec in the conventional liquid crystal display.

### Example 2

The liquid crystal display of Example 2 was configurated in the same way as Example 1, except that the water-repellant fluorinated silicone resin (TSL8233 and TSL8114, manufactured by Toshiba Silicones) was used as the resin composition forming the hydrophobic alignment layer to which hydrophilic treatment is possible.

<Liquid Crystal Display>

The liquid crystal display was produced in the same way as Example 1. In the liquid crystal display, since the liquid crystal molecule is shifted at an angle of about 90°, the content of the chiral agent in the liquid crystal layer could be reduced by about 2% compared with the conventional type of liquid crystal display. When the power of the liquid crystal display is turned on, the response time of the liquid crystal was about 15 msec, while the response time is about 20 msec in the conventional liquid crystal display.

What is claimed is:

1. A liquid crystal display of a vertically aligned type comprising a first substrate, a second substrate, and a liquid crystal layer which is inserted in between said substrates,
wherein hydrophobic alignment layers, which arranges a director of a liquid crystal molecule in a direction of normal line of the substrate, are formed on the first substrate and on the second substrate, and a hydrophilic fine pattern region, in which the director of the liquid crystal molecule is easily tilted to a predetermined direction, is formed in a part of said alignment layer.

2. The liquid crystal display according to claim 1 wherein the direction of the director of the liquid crystal molecule which is tilted in the fine pattern region formed on the first substrate and the direction of the director of the liquid crystal molecule which is tilted in the fine pattern region formed on the second substrate are shifted from each other by an angle in a range of 70° to 110°.

3. The liquid crystal display according to claim 1 wherein a shape of the fine pattern region is a triangle having an acute angle portion or a combined shape based on said triangle.

4. The liquid crystal display according to claim 2 wherein a shape of the fine pattern region is a triangle having an acute angle portion or a combined shape based on said triangle.

5. The liquid crystal display according to claim 1 wherein the alignment layer is a hydrophobic film formed of fluorinated silicone or polyimide, and the fine pattern region is a hydrophilic region in which a hydrophilic group is given to the fluorinated silicone film or the polyimide film.

6. The liquid crystal display according to claim 2 wherein the alignment layer is a hydrophobic film formed of fluorinated silicone or polyimide, and the fine pattern region is a hydrophilic region in which a hydrophilic group is given to the fluorinated silicone film or the polyimide film.

7. A liquid crystal display substrate comprising a substrate and a hydrophobic alignment layer, which is formed on the substrate and arranges a director of a liquid crystal molecule in a direction of normal line of the substrate,
wherein a hydrophilic fine pattern region, in which the director of the liquid crystal molecule is easily tilted to a predetermined direction, is formed in a part of the alignment layer.

8. The liquid crystal display substrate according to claim 7 wherein a shape of the fine pattern region is a triangle having an acute angle portion or a combined shape based on said triangle.

9. The liquid crystal display substrate according to claim 7 wherein the alignment layer is a hydrophobic film formed of fluorinated silicone or polyimide, and the fine pattern region is a hydrophilic region in which a hydrophilic group is given to the fluorinated silicone film or the polyimide film.

10. The liquid crystal display substrate according to claim 8 wherein the alignment layer is a hydrophobic film formed of fluorinated silicone or polyimide, and the fine pattern region is a hydrophilic region in which a hydrophilic group is given to the fluorinated silicone film or the polyimide film.

11. A method for manufacturing a liquid crystal display of a vertically aligned type comprising a first substrate, a second substrate, and a liquid crystal layer which is inserted in between said substrates wherein alignment layers, which arranges a director of a liquid crystal molecule in a direction of normal line of the substrate, are formed on the first substrate and on the second substrate, and a fine pattern region, in which the director of the liquid crystal molecule is easily tilted to a predetermined direction, is formed in a part of said alignment layer,
comprising processes of: forming a hydrophobic alignment layer, to which hydrophilic treatment is possible, on a surface of the first substrate and the surface of the second substrate; and
forming a hydrophilic fine pattern region by carrying out the hydrophilic treatment to a part of the alignment layer.

12. The method for manufacturing a liquid crystal display according to claim 11 wherein, in the process of forming the hydrophilic fine pattern region, a pattern to which the hydrophilic treatment is carried out is a triangle having an acute angle portion or a combined shape based on said triangle, and the shape of the pattern of the alignment layer formed on the first substrate to which hydrophilic treatment is carried out and the shape of the pattern of the alignment layer formed on the second substrate to which hydrophilic treatment is carried out are shifted from each other, on a plane view, by an angle in a range of 70° to 110°.

13. The method for manufacturing a liquid crystal display according to claim 11 wherein the hydrophilic treatment is carried out by exposure treatment using a mask having a photocatalyst layer.
